(19) United States
(12) Patent Application Publication
(10) Pub. No.: US 2004/0232347 A1
(43) Pub. Date: Nov. 25, 2004

(54) Systems for detection imaging and absorption of radiation using a special substrate

(76) Inventors: Leonid Melekhov, Kiryat Ekron (IL); Asaf Zuck, Jerusalem (IL); Haim Hermon, Jerusalem (IL)

Correspondence Address: SQUIRE, SANDERS & DEMPSEY L.L.P, 600 HANSEN WAY, PALO ALTO, CA, 94304-1043, US

(21) Appl. No.: 10/481,350

(22) PCT Filed:
(86) PCT No.: PCT/IL02/00469

(30) Foreign Application Priority Data
Jun. 19, 2001 (IL) 143850

(51) Int. Cl. H01L 31/00

(52) U.S. Cl. 250/370.12

(57) ABSTRACT

A radiation detection and imaging system, which includes at least one radiation detecting and imaging element comprising a planar substrate, a surface of which has been seeded with mercuric iodide grains having a diameter in the range of about 0.01-1.0 micron, before being subjected to a step of deposition thereon of a layer of polycrystalline mercuric iodide having a thickness of up to about 3000 microns. A process for preparing an element such as the one described. A planar substrate, wherein a surface thereof has been seeded with mercuric iodide grains having a diameter in the range of about 0.01-1.0 micron. A physical vapor deposition method for preparing a radiation detecting and imaging element comprising a planar substrate by deposition of a film of mercuric iodide having a maximum thickness of about 3000 microns on a surface on the substrate.

### FIELD AND BACKGROUND OF THE INVENTION

The present invention relates to a radiation detection and imaging system, a planar substrate for use in this system, a surface of which has been seeded with mercuric iodide, a process for preparing the seeded substrate and a physical vapor deposition method for preparing a radiation detecting and imaging element.

Polycrystalline HgI₂ films are known to be produced by Physical Vapor Deposition (PVD), which process may be regarded as proceeding in two overlapping stages. In the primary stage, isolated nucleons form on the substrate, on sites termed “nucleation centers”, which are thermodynamically preferred for clusters of atoms and/or molecules to form nucleons. This primary stage is influenced by properties of the substrate, in particular the type of material including the presence of impurities, its temperature, and its roughness including atomic and nano scale irregularities, and micro defects such as scratches. Such factors determine the energy of nucleation centers, their density and uniformity. The secondary stage, which occurs after the nucleons have matured into stable crystals, is referred to as “growth”. Low density of nucleation centers on a near-perfect initial substrate surface, which thus lacks sufficient low energy sites, leads to selective crystal growth, with large crystals which are usually randomly oriented, in addition to high film porosity, low grain uniformity of the deposited film, lack of preferred orientation, and an undesirably rough final surface intended for detection and/or imaging of radiation (see FIGS. 1A and 1B). It will be appreciated that in the prior art, after an initial low density formation of nucleation centers, the primary and secondary stages will occur to a great extent simultaneously. To the best of the present inventors' knowledge, it has not been previously suggested to separate the primary and secondary stages.

It is a principal object of the present invention to avoid such undesirable consequences of the prior art procedure, by initially preparing a seeded substrate surface as a discrete step, prior to the growth stage. Other objects of the invention will appear from the description which follows.

### SUMMARY OF THE INVENTION

The present invention provides in one aspect, a radiation detection and imaging system, which includes at least one radiation detecting and imaging element comprising a planar substrate, a surface of which has been seeded with mercuric iodide grains having a diameter in the range of about 0.01-1.0 micron, before being subjected to a step of deposition thereon of a layer of polycrystalline mercuric iodide having a thickness of up to about 3000 microns.

In another aspect, the invention provides an element comprising a planar substrate and adapted for use as stated in the preceding paragraph, wherein a surface of the substrate has been seeded with mercuric iodide grains having a diameter in the range of about 0.01-1.0 micron, before being subjected to a step of deposition of a layer of polycrystalline mercuric iodide having a thickness of up to about 3000 microns. The seeded planar substrate as just described also constitutes per se part of the present invention.

In yet another aspect, the present invention provides a process for preparing an element comprising a planar substrate and adapted for use in a radiation detection and imaging system, which comprises the sequential steps of:

(i) seeding a surface of the substrate with mercuric iodide grains having a diameter in the range of about 0.01-1.0 micron; and

(ii) depositing on the thus-seeded surface a layer of polycrystalline mercuric iodide having a thickness of up to about 3000 microns.

In still a further aspect, the invention provides, in a physical vapor deposition method for preparing a radiation detecting and imaging element comprising a planar substrate by deposition of a film of mercuric iodide on a surface thereof, the improvement which comprises carrying out the deposition in at least one prior stage before a final deposition stage, and subjecting to shear stress (e.g. by polishing) the surface of deposited mercuric iodide produced in at least one deposition stage before said final deposition stage; and a radiation detection and imaging system, which includes at least one radiation detecting and imaging element thus prepared.

The present invention also provides a planar substrate, having deposited on a surface thereof, a film of mercuric iodide (preferably having a columnar type morphology) in at least two discrete adjacent layers having a total thickness within the range of from 8 to about 3000 microns.

### BRIEF DESCRIPTION OF THE DRAWINGS

FIG. 1 shows a SEM image of a top view (1A) and cross-section (1B) of a prior art unseeded PVD HgI₂ layer.

FIG. 2 illustrates an exemplary scheme of a known physical vapor deposition (PVD) system for HgI₂ deposition.

FIG. 3 shows an AFM image of an HgI₂ seeded substrate surface, in accordance with an embodiment of the present invention.

FIG. 4 shows a SEM image of cross section of an HgI₂ film PVD-deposited on a seeded substrate surface, in accordance with an embodiment of the present invention.

FIG. 5 shows an AFM image of an HgI₂ seeded substrate surface after polishing, In accordance with an embodiment of the present invention.

FIG. 6 shows a SEM image of a top view (6A) and cross-section (6B) of an HgI₂ film PVD-deposited on a seeded and subsequently polished substrate surface, in accordance with an embodiment of the present invention.

FIG. 7 shows an XRD of an HgI₂ film PVD-deposited on a seeded and subsequently polished substrate surface, in accordance with an embodiment of the present invention.

FIG. 8 shows a SEM image of a cross-section of an HgI₂ film PVD-deposited on a substrate surface, in accordance with an embodiment of the present invention.

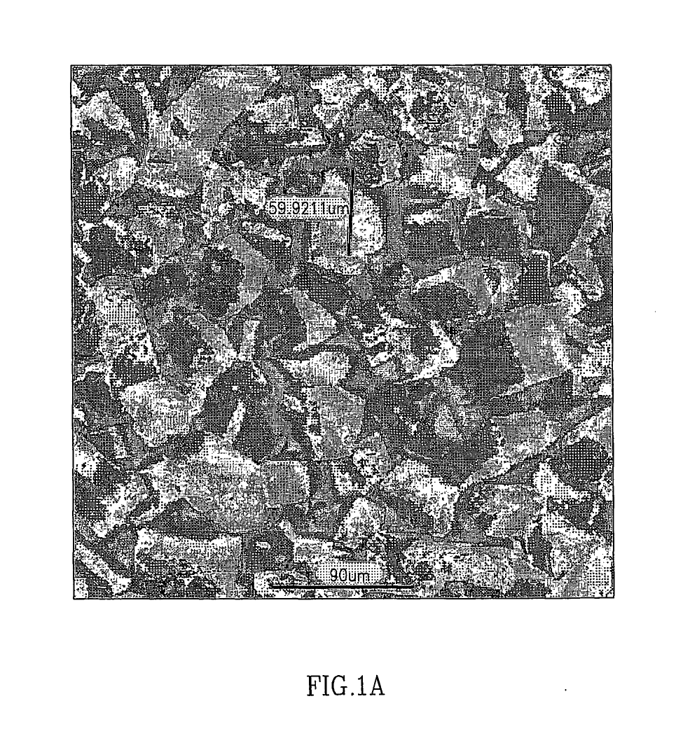

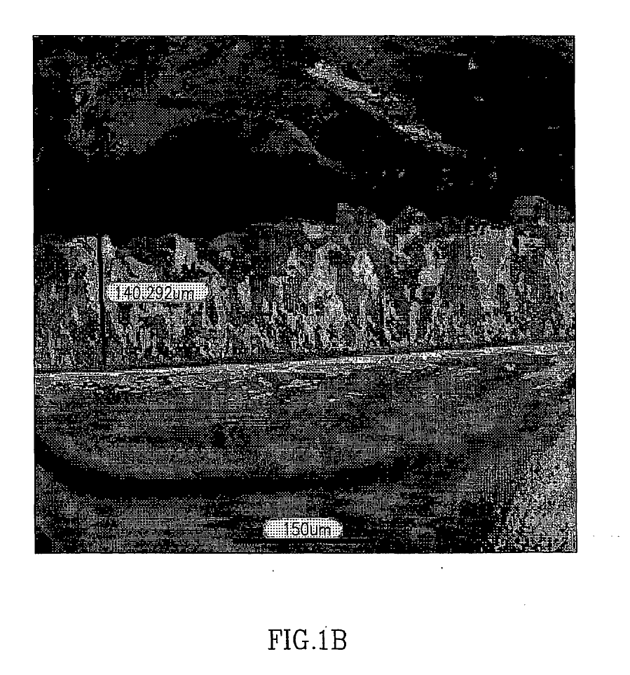

### DETAILED DESCRIPTION OF THE INVENTION

The present invention requires use of a planar substrate, which is to be seeded with mercuric iodide. Exemplary substrates are gold, indium-tin oxide (ITO), and multiplexed substrates, such as amorphous silicon Flat Panels (FP). Substrates may be polymer coated, e.g. with at least one polymer selected from the group consisting of aliphatic and aromatic ethylenic homo- and co-polymers (i.e., homo- and co-polymers of aliphatic ethylene monomers, or of ethylenic monomers containing at least one aromatic ring such as styrene or substituted styrenes), and mixtures thereof, such as, for example, Humiseal™ (a polyacrylic, polyvinylic mixture in a mixed methyl ethyl ketone/toluene solvent) or polystyrene.

In a particular embodiment of the invention, either after formation, or simultaneously therewith, the seeded substrate surface is subjected to shear stress, such as by polishing with a suitable cloth or pad. This action breaks down the polycrystalline mercuric iodide into smaller grains, increases the number of grains per unit area of substrate surface and tends to convert the less desired orthorhombic component of the crystal structure to the desired tetragonal form.

By the expression “or simultaneously therewith” throughout the specification and claims, it is intended to convey that in a particular embodiment, the unseeded substrate is subjected to a polishing action in presence of mercuric iodide particles, spread on the polishing cloth or pad, and/or on the substrate, whereby the particles adhere to the substrate on the one hand, and on the other hand are simultaneously broken down into smaller, desired particles.

For use in a radiation detection/imaging system, the seeded substrate is subjected to the growth stage deposition of mercuric iodide by generally known PVD methods. This growth stage deposition may be effected in a single step, or in two or more sub-steps, as desired. Optionally, when two or more such sub-steps are carried out, the polycrystalline mercuric iodide surface formed after at least one such sub-step is subjected to shear stress (e.g., by polishing) before a subsequent sub-step is effected.

The total thickness of the HgI₂ layer deposited in the growth stage will be up to about 3000 microns, e.g. up to about 500 microns, such as within the range of 8-250 microns, e.g. 50-200 microns.

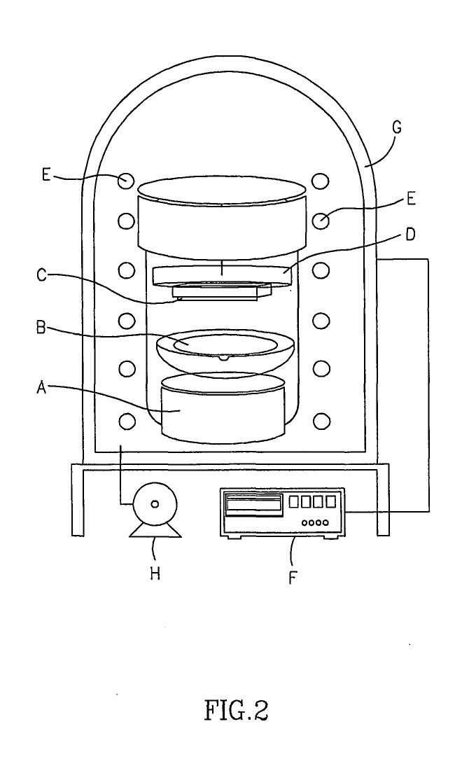

An exemplary PVD system for carrying out the HgI₂ growth step of the present invention is shown in FIG. 2, wherein, in bell jar G under a vacuum of 10⁻³ torr, controlled by pump H, HgI₂ in a suitable dish B, by action of heater A, sublimes and is thus deposited on substrate C attached to holder D, while the walls of G are heated by vertical coil heating element E, controlled by thermostat F. Characteristic deposition temperatures are 140° C. for the source and 80-85° C. for the substrate.

The invention will be illustrated by the following Examples.

### EXAMPLE 1

### Seeding a Substrate Surface by Vaporization of Mercuric Iodide

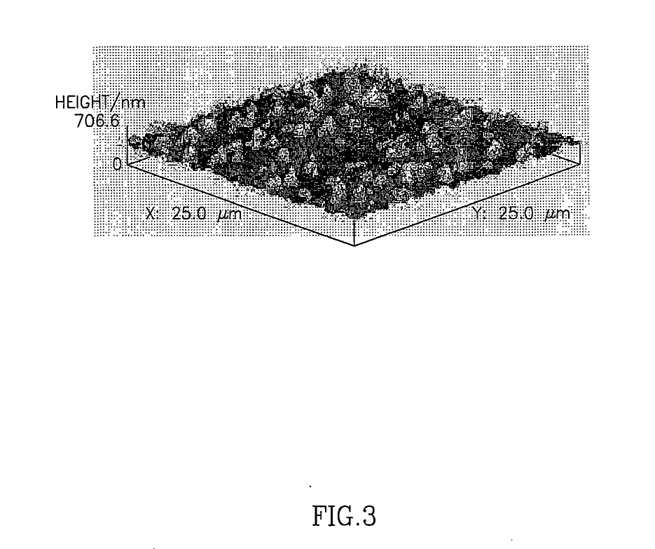

HgI₂, placed in a Petri dish, is covered and heated to 120-200° C., more preferably 150° C. The cover is removed, and an uncoated gold on glass substrate at room temperature held over the HgI₂ vapors for approximately 20 seconds. The seeded surface contains mercuric iodide crystallites (α-HgI₂ and β-HgI₂ phases), in essentially a monolayer where the seeds have an approximate diameter of about 0.3 to 0.4 (e.g. 0.35) μm. The surface density is about 30 seeds per 100 μm². The resulting seeded but unpolished surface, on which is deposited very fine and uniform grains of mercuric iodide, is shown in FIG. 3.

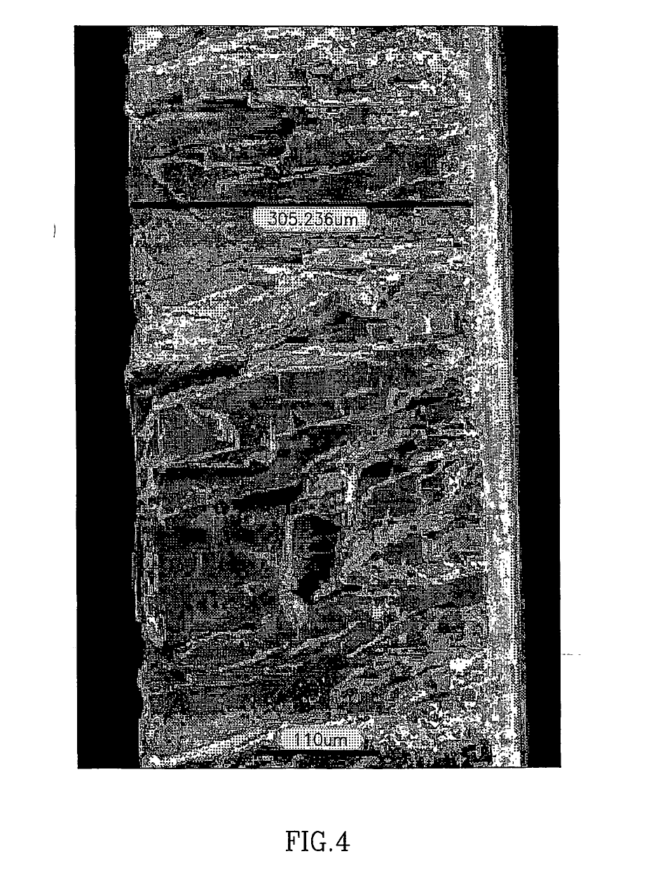

This unpolished seeded surface is coated with mercuric iodide according to the standard PVD procedure (see e.g. Example 4, infra), when a dense polycrystalline film with a fine-grained columnar structure and a flatter surface than in the case of the prior art, is obtained, as shown in FIG. 4.

When required (e.g. in the case of an ITO substrate), or otherwise desired, the initial substrate may be coated with a layer of polymer, such as Humiseal. The polymer coating can be effected by standard techniques such as immersion, spin coating, spraying, etc.

### EXAMPLE 2

### Polishing a Seeded Substrate Surface

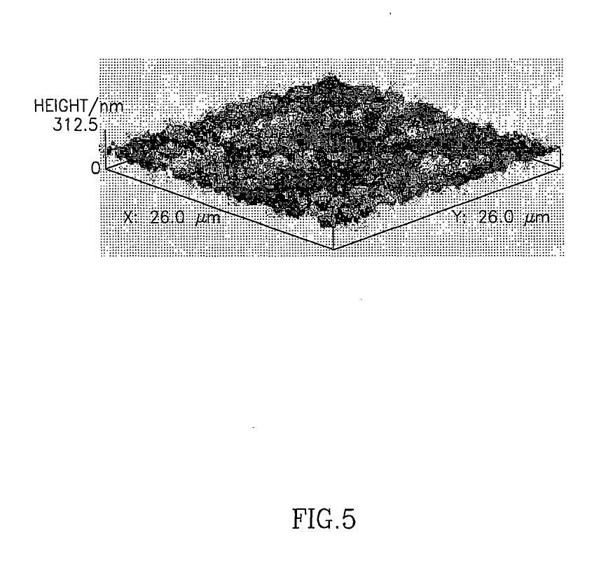

The seeded substrate prepared in Example 1 is polished by means of a clean Struer's #40500002 cloth/pad, without addition of any HgI₂ powder, until a shinning, mirror-like, semi-transparent slightly reddish surface is obtained. This polishing step breaks the crystallites, reducing their average size to about 0.1 μm and increasing their density to about 200 seeds per 100 μm². The resulting polished surface is shown in FIG. 5. It may be noted that the crystals in FIG. 5 are of the tetragonal α-phase (reddish appearance), whereas those in FIG. 3 are of the orthorhombic β-phase (yellow appearance).

### EXAMPLE 3

### Polishing an Unseeded Substrate Surface

An unseeded substrate surface is polished by means of a clean Struer's #40500002 cloth/pad, having spread thereon (and/or on the substrate surface) fine HgI₂ grains, e.g. those passing a 20 micron sieve and containing predominantly 10-20 μm grains), until a shinning, mirror-like, semi-transparent slightly reddish surface is obtained. The polishing action breaks the grains, reducing their average size to about 0.1 to 0.15 μm, while simultaneously adhering them to the substrate surface, at a density of about 200 grains (seeds) per 100 μm². When required (e.g. in the case of an ITO substrate), or otherwise desired, the initial substrate may be coated with a layer of polymer, such as Humiseal. The polymer coating can be effected by standard techniques such as immersion, spin coating, spraying, etc.

### EXAMPLE 4

### Growth of Mercuric Iodide on a Polished Seeded Substrate Surface

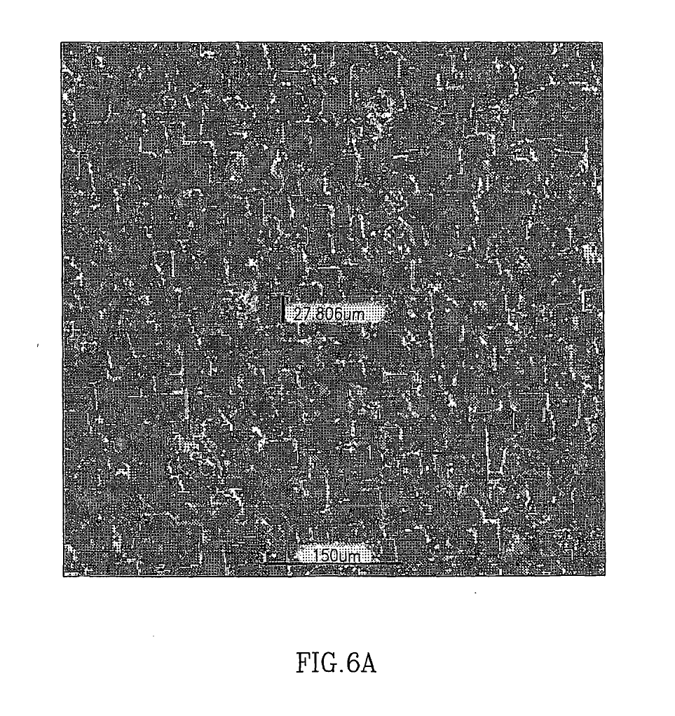

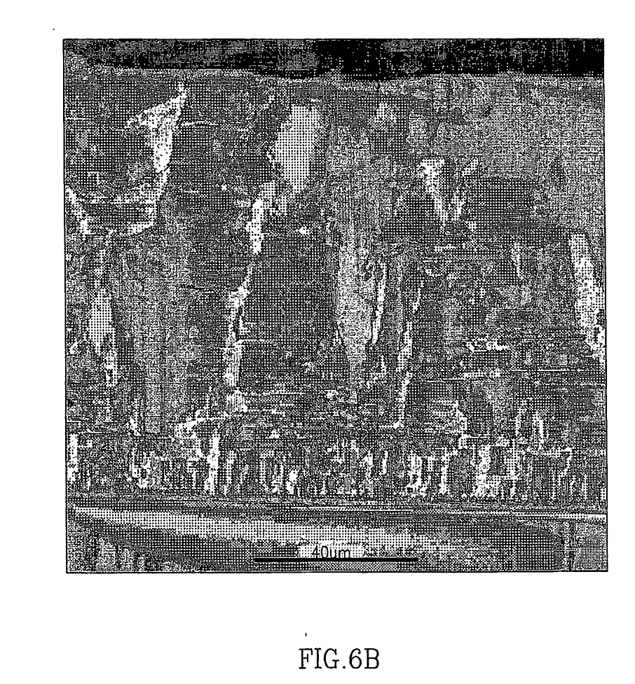

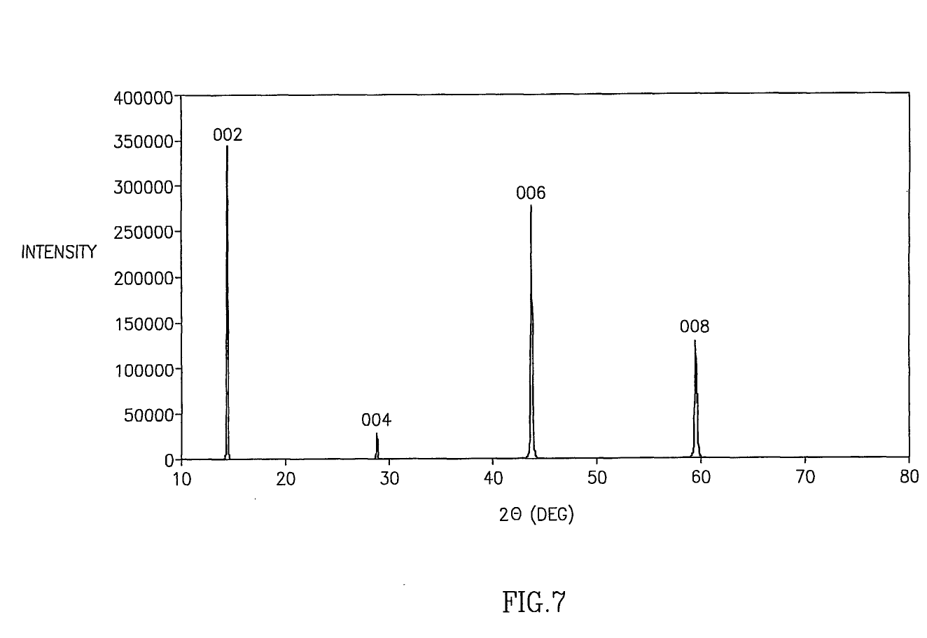

A polished and previously or simultaneously seeded substrate prepared similarly to the procedure described in Example 2 or 3, except that the substrate was coated ITO on glass (the coating being ˜0.5 Humiseal 1B12—a polyacrylic, polyvinyl mixture in a mixed methyl ethyl ketone/toluene solvent), is subjected to the standard PVD method, in order to deposit a layer of HgI₂, having a thickness of e.g. 100 microns. As revealed by SEM in FIGS. 6A and 6B, the substrate surface thus prepared provides a denser and smoother polycrystalline film with a highly oriented columnar structure, compared with the prior art. The product also has an XRD very similar to that referred to below (FIG. 7).

If instead of deposition of a 100 micron thick layer in one step, there is deposited a layer of HgI₂, having a thickness of 150 microns in three sub-steps of ˜50 microns each, cooling the substrate to ambient temperature between each sub-step and polishing with a clean Struer's #40500002 cloth/pad, before proceeding, the film produced has a highly oriented columnar structure, compared with the prior art, as revealed by the high intensity [0,0,I] peaks in the XRD pattern (FIG. 7). The products of this Example provide higher resolution in a direct X-ray imaging digital detector and improved characteristics uniformly over the whole irradiated imaging surface.

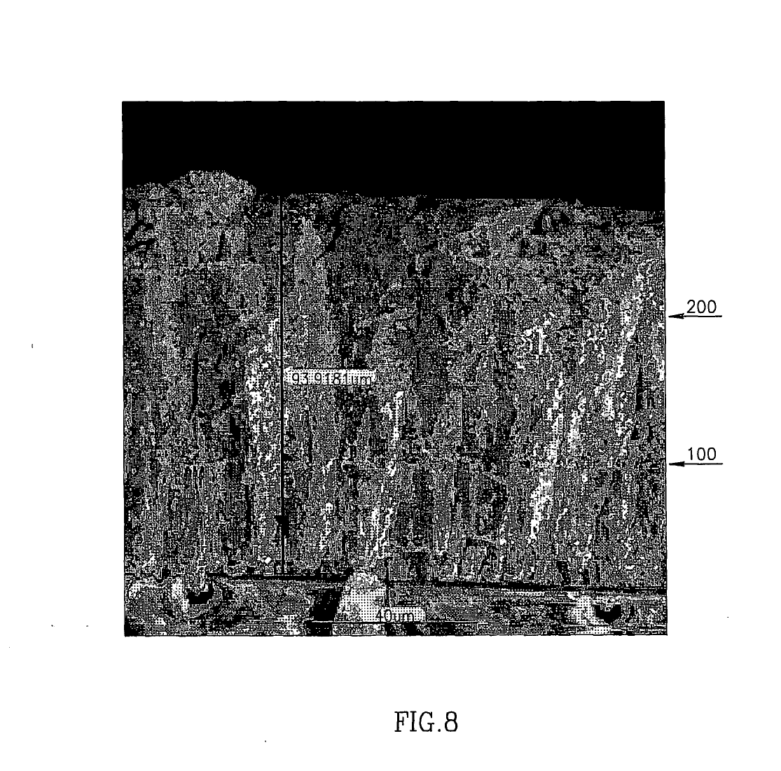

FIG. 8 shows a cross-section of the film having the 150 micron thickness, where the deposition is carried out in three sub-steps. The interfaces between the first and second sub-layers (interface 100) and the second and third sub-layers (interface 200) are clearly visible. The continuity of the columnar structure across the interfaces is notable.

### ADVANTAGES OF THE INVENTION

By carrying out seeding and growth in respective discrete operations, there is achieved a deposited mercuric iodide layer on a substrate surface, which layer has a high density (no, gaps between crystallites), a preferred crystallite structure and orientation (tetragonal as opposed to orthorhombic, with a columnar structure), a high standard of perfection, and a smooth surface. The thus-formed polycrystalline HgI₂ detector/digital imaging element for direct ionizing (e.g. X-ray) radiation (such as X-ray), has a high X-ray absorption and low energy electron-hole generation, providing a high output signal per one X-ray quantum and wide band gap, operable at ambient temperatures and has a high spatial uniformity of response across the detector. In particular the image has a much improved resolution and therefore clarity, compared with analogous prior art ionizing radiation images.

While the present invention has been particularly described with reference to certain embodiments, it will be apparent to those skilled in the art that many modifications and variations may be made. Merely by way of example, it is presently contemplated that a seeded substrate surface in accordance with the present invention could be formed by deposition of mercuric iodide on a substrate surface from its solution or suspension in water and/or organic solvents. The invention is accordingly not to be construed as limited in any way by the illustrated embodiments, rather its concept is to be understood according to the spirit and scope of the claims which follow.

1. A radiation detection and imaging system, which includes at least one radiation detecting and imaging element comprising a planar substrate, a surface of which has been seeded with mercuric iodide grains having a diameter in the range of about 0.01-1.0 micron, before being subjected to a step of deposition thereon of a layer of polycrystalline mercuric iodide having a thickness of up to about 3000 microns.

2. A system according to claim 1, which is also characterized by at least one of the following features:
(a) after formation, or simultaneously therewith, said seeded substrate surface is subjected to shear stress;
(b) said layer of polycrystalline mercuric iodide is deposited in at least two successive deposition sub-steps;
(c) said planar substrate is a polymer-coated planar substrate.

3. A system according to claim 2, which is further characterized by at least one of the following features:
(a) said shear stress is effected by polishing said seeded substrate surface;
(b) the polycrystalline mercuric iodide surface formed after at least one such sub-step is subjected to shear stress before a subsequent sub-step is effected;
(c) said polymer is selected from the group consisting of aliphatic and aromatic ethylenic homopolymers and copolymers, and mixtures thereof.

4. An element adapted for radiation detection and imaging, which comprises a planar substrate, a surface of which has been seeded with mercuric iodide grains having a diameter in the range of about 0.01-1.0 micron, before being subjected to a step of deposition thereon of a layer of polycrystalline mercuric iodide having a thickness of up to about 3000 microns.

5. An element according to claim 4, which is also characterized by at least one of the following features:
(a) after formation, or simultaneously therewith, said seeded substrate surface is subjected to shear stress;
(b) said layer of polycrystalline mercuric iodide is deposited in at least two successive deposition sub-steps;
(c) said planar substrate is a polymer-coated planar substrate.

6. An element according to claim 5, which is further characterized by at least one of the following features:
(a) said shear stress is effected by polishing said seeded substrate surface;
(b) the polycrystalline mercuric iodide surface formed after at least one such sub-step is subjected to shear stress before a subsequent sub-step is effected;
(c) said polymer is selected from the group consisting of aliphatic and aromatic ethylenic homopolymers and copolymers, and mixtures thereof.

7. A planar substrate, wherein a surface thereof which has been seeded with mercuric iodide grains having a diameter in the range of about 0.01-1.0 micron.

8. A seeded substrate according to claim 7, which has been coated with polymer prior to seeding.

9. A seeded substrate according to claim 8, wherein said polymer is selected from the group consisting of aliphatic and aromatic ethylenic homopolymers and copolymers, and mixtures thereof.

10. A seeded substrate according to claim 7, wherein after its formation or simultaneously therewith, said seeded surface is subjected to shear stress.

11. A seeded substrate according to claim 10, which has been coated with polymer prior to seeding.

12. A seeded substrate according to claim 11, wherein said polymer is selected from the group consisting of aliphatic and aromatic ethylenic homopolymers and copolymers, and mixtures thereof.

13. A seeded substrate according to claim 10, wherein said shear stress is effected by polishing said seeded substrate surface.

14. A seeded substrate according to claim 13, which has been coated with polymer prior to seeding.

15. A seeded substrate according to claim 14, wherein said polymer is selected from the group consisting of aliphatic and aromatic ethylenic homopolymers and copolymers, and mixtures thereof.

16. A process for preparing an element comprising a planar substrate and adapted for use in a radiation detection and imaging system, which comprises the sequential steps of:
(a) seeding a surface of said substrate with mercuric iodide grains having a diameter in the range of about 0.01-1.0 micron; and
(b) depositing on said seeded surface a layer of polycrystalline mercuric iodide having a thickness of up to about 3000 microns.

17. A process according to claim 16, wherein said seeded surface is also characterized by at least one of the following features:
said seeded surface is subjected to shear stress, prior to step (b);
said layer of polycrystalline mercuric iodide is deposited in at least two successive sub-steps;
said planar substrate is a polymer-coated planar substrate.

18. A process according to claim 17, which is further characterized by at least one of the following features:
(a) said shear stress is effected by polishing said seeded substrate surface;
(b) the polycrystalline mercuric iodide surface formed after at least one such sub-step is subjected to shear stress before a subsequent sub-step is effected;
(c) said polymer is selected from the group consisting of aliphatic and aromatic ethylenic homopolymers and copolymers, and mixtures thereof.

19. In a physical vapor deposition method for preparing a radiation detecting and imaging element comprising a planar substrate by deposition of a film of mercuric iodide having a maximum thickness of about 3000 microns on a surface on said substrate, the improvement which comprises carrying out the deposition in at least one prior stage before a final deposition stage, and subjecting to shear stress the surface of deposited mercuric iodide produced in at least one deposition stage before said final deposition stage.

20. A radiation detection and imaging system, which includes at least one radiation detecting and imaging element prepared by the method of claim 19.

21. A method according to claim 19, wherein said shear stress is effected by polishing.

22. A radiation detection and imaging system, which includes at least one radiation detecting and imaging element prepared by the method of claim 21.

23. A planar substrate, having deposited on a surface thereof, a film of mercuric iodide in at least two discrete adjacent layers having a total thickness within the range of from 8 to about 3000 microns, shear stress having been applied to the surface of at least one discrete layer prior to deposition of a next adjacent layer.

24. A substrate according to claim 23, wherein said shear stress has been applied by polishing.

25. A substrate according to claim 23, wherein said film of mercuric iodide has a columnar type morphology.

26. A planar substrate coated with polycrystalline mercuric iodide such that the coating exhibits an XRD pattern having high intensity [0,0,1] peaks.

27. A planar substrate coated with polycrystalline mercuric iodide such that the coating exhibits a highly oriented, dense morphology with a smooth surface.
